(19) United States
(12) Patent Application Publication
(10) Pub. No.: US 2012/0004338 A1
(43) Pub. Date: Jan. 5, 2012

(54) Polymer and Method of Forming a Polymer

(75) Inventor: Duncan Hywel-Evans, Sydney (AU)

(73) Assignee: Adbruf Ltd., Stalbridge (GB)

(21) Appl. No.: 13/141,656

(22) PCT Filed: Dec. 18, 2009
(86) PCT No.: PCT/GB09/51737

§ 371 Date: Sep. 9, 2011

(30) Foreign Application Priority Data
Dec. 23, 2008 (GB) 0823542.6

(51) Int. Cl. C09D 179/04; B32B 37/12; C08G 73/06

(52) U.S. Cl. 521/156; 528/68; 524/589; 156/331.7

(57) ABSTRACT

The present invention provides a method of forming a polymer, the method comprising reacting a first species comprising at least one isocyanate group with a second species comprising at least one aziridine group to form the polymer.

### FIELD OF THE INVENTION

The present invention relates to polymers and other species that are formable from the reaction between an isocyanate and an aziridine, generally without the need for a catalyst and without the need for heating the reaction mixture. They are suitable for use, inter alia, in forming durable coatings.

### BACKGROUND TO THE INVENTION

A significant proportion of the present polymer industry is based upon isocyanate chemistry. Isocyanates are species that contain the isocyanate group, —N═C═O. Polyisocyanates, i.e. species containing more than one isocyanate group, can be used to make polymers such as polyurethanes and polyamides. Many polyurethanes are formed by combining a diisocyanate with a diol, as illustrated by the reaction below:

(n+1)×O═C═N—R′—N═C═O+(n+1)×HO—R″—OH→HO—R″—O—[—CO—N—R′—N—CO—O—R″—O —]ₙ—CO—NH—R′—N═C═O

Polyurethanes contain the urethane linkage: —N—CO—O—, which can be seen in the repeating unit in the polymer shown above. In the above reaction, the diisocyanate and the diol are used in a molar ratio of 1:1 (a stoichiometric ratio). However, polyurethane polymers may be formed where the ratio of diisocyanate and diol is not stoichiometric, depending on the desired outcome of the polymerisation.

In a similar manner, a polyurea may formed by combining a diisocyanate with a diamine as illustrated below:

(n+1)×O═C═N—R′—N═C═O+(n+1)×H₂N—R″—NH₂—H₂N—R″—NH—[—CO—NH—R′—N—CO—N—R″—NH—]ₙ—CO—NH—R′—N═C═O

Polyureas contain the urea linkage: —N—CO—N, which can be seen in the repeating unit in the polymer shown above. Again, although in the reaction above the molar ratio of diisocyanate and diamine is 1:1, the molar ratio of these two species need not be stoichiometric, depending on the desired outcome of the polymerisation.

Alternatively, polyureas can be formed by providing a polyisocyanate and exposing it to water. Water will react with an isocyanate group to form a carbamic acid (—NH—(CO)—OH), which then loses carbon dioxide, forming an amine, which can then react with an isocyanate group of another molecule to form a urea linkage.

Polyurethane and polyureas have many applications in industry. Polyurethanes can be formed into flexible or rigid materials. They may also be foamed. They find use in many applications, such as in paints, interior surfaces of automobiles, hydrogels, upholstery and insulation materials. Polyureas are generally very hard, durable plastics and are used for coating exterior surfaces of, for example, some buildings and civil engineering structures.

Polyurethanes and polyureas are further described in many textbooks, for example, in Plastics Materials, Seventh Edition, authored by J. A. Brydson and published by Butterworth Heinemann in 1999, in particular Chapter 27, pages 778 to page 808, which is incorporated herein by reference.

The process for making polyurethanes and polyureas generally involves combining the monomers in the presence of a catalyst and other optional ingredients, such as ‘blowing agents’ (if producing a foam), and surfactants. Catalysts for polyurethane production include, for example, amine compounds such as triethyldiamine or organometallic complexes, which can contain metals such as mercury, lead, tin bismuth and zinc.

While the polyurethanes and polyureas are useful polymeric materials, there is a desire to produce alternative polymeric materials. It is an aim to overcome or mitigate at least some of the problems associated with the prior art polymers. Ideally, they should have improved properties, such as hardness and/or strength and/or be producible in a more efficient process, e.g. without the need for a catalyst.

Some aziridines have been known to react under certain conditions with isocyanates. For example, an article authored by Kim et al (Chem. Commun., 2005, 3062-3064), discloses the Lewis acid-catalysed ring expansion reaction of a chiral aziridine 2-carboxylate. In the reactions, a chiral monoaziridine is reacted with a monoisocyanate to produce an imidazolidin-2-one. No polymerisation reaction is disclosed in this document.

A further example of the reaction of an aziridine with an isocyanate is disclosed in a journal article authored by Munegumi et al (Org. Lett., 2006, 8, 379-382). In these reactions, Nil₂ catalyses the reaction of the monoaziridine, 1-benzylaziridine, with a aromatic monoisocyanate to form iminooxazolidine and imidazolidinone derivatives. No polymerisation reaction is disclosed in this document.

US 2003/0208033 discloses a process for reducing the monomeric aziridines in a polyaziridines reaction, which in this document means a polymer formed from an aziridine, by adding an isocyanate as a scavenger. There is no disclosure of water being present in reaction between the aziridines and the isocyanates, nor any disclosure of the type of products formed.

U.S. Pat. No. 6,365,679 discloses a two component polyurethane clear coat for golf balls. The polyurethane clear coat principally includes two components, a polyol component and an isocyanurate component. This document mentions that the polyol component may further include an epoxidised silane and a polyfunctional aziridine. There is no disclosure of which polyfunctional aziridine could be used, nor whether there is any reaction between the polyfunctional aziridine in the polyol component and the isocyanurate. There is no disclosure of water being present in either component.

JP 2001-213879 discloses a reaction between a uretedione and aziridine. No polymer is formed in this reaction.

U.S. Pat. No. 3,560,415 discloses foam plastics based on compounds with reactive hydrogen atoms, organic polyisocyanates and water as blowing agent. Aziridines may be present in the process for producing the foam plastics. The aziridines are monoaziridines. The aziridine species has at least one aziridine ring in which the nitrogen atom is bonded to a methylene group and at least in the case where only one aziridine ring is present in the molecule the compound has at least one hydrogen atom that is reactive with isocyanates. Examples of such aziridines include 1-(2-aminoethyl)-aziridine, 1-(2-methylamino-ethyl)-aziridine, 1-azridinomethanol and 1-(2-hydroxylethyl)-aziridine. In the processes of this document, an organic compound with reactive hydrogen atoms (according to the Zerewitinoff method) must be present.

Examples include polyhydroxyl compounds such as hydroxyl containing polyesters obtained from polycarboxylic acids and di- and higher functional polyols, polyols, hydroxyl-containing polyethers, polyacetals, polyester amides and polycarbonates. It is believed that in this process, the isocyanate will react with the reactive groups having reactive hydrogen atoms attached (e.g. the primary amines and hydroxyl groups), rather than the aziridines.

### BRIEF DESCRIPTION OF THE INVENTION

The present invention relates to a reaction between a species containing at least one isocyanate group and a species containing at least one aziridine group, optionally in the presence of water, and the products formed in this reaction. The present invention relates to polymers and other species that are based on a reaction between an isocyanate group and an aziridine group, optionally in the presence of water. The present invention relates to a method of forming a polymer from a species containing an isocyanate group and a species containing an aziridine group. The species containing an isocyanate group is termed a first species herein. The species containing an aziridine group is termed a second species herein. The present invention also relates to a method of polymerising a species containing an isocyanate group and an aziridine group. Accordingly, the present invention provides the following aspects.

In a first aspect, the present invention provides a method of forming a polymer, the method comprising reacting a first species comprising at least one isocyanate group with a second species comprising at least one aziridine group to form the polymer.

In a second aspect, the present invention provides a polymer formable by the method of the present invention.

In a third aspect, the present invention provides a polymer formable from the polymerisation of a first species comprising at least one isocyanate group with a second species comprising at least one aziridine group.

In a fourth aspect, the present invention provides a substrate having a coating thereon, wherein the coating comprises a polymer of the present invention.

In a fifth aspect, the present invention provides a moulded article comprising a polymer of the present invention.

In a sixth aspect, the present invention provides an article comprising a first substrate and a second substrate, wherein first and second substrate are adhered together by the polymer of the present invention.

In a seventh aspect, the present invention provides a method of combining a first species with a second species in the presence of water to form a third species, the first species comprising at least one isocyanate group and the second species comprising at least one aziridine group. The third species may be a polymer. The combining of the first and second species may be a condensation reaction and optionally the combining of the first and second species may result in the loss of CO₂. The first and second species may be as defined herein. The first and second species may be as defined herein for the other aspects of the invention.

The polymer formed in the method of the present invention may be formed very fast without a catalyst being present. In some cases, the reaction can happen in seconds. The polymerisation has been found to be particularly fast when water is present, even if simply in the form of atmospheric moisture. While not being bound by theory, it is believed that the method of the present invention, when water is present, proceeds via a route which involves the loss of CO₂ from the isocyanate species, before or after, most likely after, combination with the aziridine species. Aliphatic isocyanates, i.e. those in which an alkylene group is directly bonded to the isocyanate, have been found to perform particularly well in the formation of a polymer, and are much preferred over aromatic isocyanates. The resultant polymer is believed to be a polyamine compound. The polymers formed are generally solid and durable and can be used in many applications. Foamed polymers may be formed using the method of the present invention. The polymers of the present invention are particularly suited to forming hardened coatings.

### DETAILED DESCRIPTION OF THE INVENTION

The present invention provides the first to seventh aspects as described above. Preferably, the method involves loss of CO₂ from the isocyanate species. CO₂ gas may be produced in the method.

Preferably, in the method of the first aspect, the reaction or polymerisation is carried out in the presence of water or a water-containing gas, as described below.

### First Species

The first species comprises at least one isocyanate group (—N═C═O) on each molecule. The first species may be same as or different from the second species.

The first species may comprise a single isocyanate group on each molecule. The first species may comprise a polyisocyanate. A polyisocyanate is a species having two or more isocyanate groups on each molecule. The first species may comprise an aliphatic or aromatic isocyanate; aliphatic isocyanates are preferred. Such isocyanates are known to those skilled in the art, for example for use in producing polyurethanes. Preferably, the first species comprises at least one alkyleneisocyanate group. The first species may comprise at least two alkyleneisocyanate groups.

Aliphatic isocyanates include, but are not limited to, an isocyanate species in which at least one isocyanate group is directly attached to an aliphatic group, such as an alkylene group, alkyl group, alkenylene group, alkenyl group, alkynylene group or alkynyl group; alkyl and alkylene groups are preferred. Examples of aliphatic polyisocyanates include ethylene diisocyanate, 1,6-hexamethylene diisocyanate (HDI), isophorone diisocyanate (IPDI), cyclohexane 1,4-diisocyanate, 4,4′-dicyclohexylmethane diisocyanate (H12MDI), and mixtures thereof.

The first species may comprise a mixture of isocyanates, such as those mentioned above.

If the first species comprises a single isocyanate group on each molecule, it may further comprise one or more other groups on the molecule that can react and form a bond with either an isocyanate group or an aziridine group. The one or more other groups may, for example, be one or more aziridine groups. In an embodiment, each of the first and second species includes at least one isocyanate group and at least one aziridine group, and the first and second species may be the same or different. If the first and second species are the same, a homopolymerisation may be carried out. Accordingly, the present invention provides a method of forming a polymer comprising polymerising a species comprising at least one isocyanate group and at least one aziridine group on each molecule. A species containing an isocyanate group and an aziridine group may, for example, have the formula O═C═N—R^{a}—N(CH₂)₂, wherein R^{a} is an organic linker group, optionally an alkylene group, such as a (CH₂)ₙ, where n is from 1 to 10.

The first species may comprise an isocyanate-functional prepolymer, preferably formed from one or more polyisocyanates. Prepolymers are known to those skilled in the art. They are generally oligomers, which are formed from two different species or monomers, and which may be further polymerised. An isocyanate-functional prepolymer may have one or more isocyanate groups, preferably one or more alkyleneisocyanate groups, as substituents on the backbone of the prepolymer (i.e. as pendant groups on the polymer) and/or as groups that terminate the polymer. Prepolymers of aliphatic isocyanates are preferred, since low molecular weight aliphatic isocyanates tend to be toxic, and prepolymers of such isocyanates are generally easier to handle.

The first species may comprise an isocyanate-terminated prepolymer, preferably formed from one or more polyisocyanates. Such prepolymers are known to those skilled in the art and have been used, for example, in polyurethane production. The isocyanate-terminated prepolymer may be formed from an aliphatic polyisocyanate, such as those mentioned above, with another isocyanate-reactive compound, including, but not limited to, a polyol; generally the polyisocyanate is reacted in stoichiometric excess with the isocyanate-reactive compound, as the skilled person would appreciate, such that an isocyanate-terminated species is produced. In the present invention, the prepolymer may have at least two isocyanate groups, which can react with an aziridine group. The pre-polymer may, for example, be formed from a polyol and an isocyanate species. The polyol may, for example, be a diol. For example, a diol and an isocyanate species, optionally a diisocyanate species, may be reacted to form a prepolymer, where preferably the isocyanate is used in molar excess, preferably such that the molar ratio of isocyanate:diol is n:1, where n is 1.5 or more, preferably 2 or more. Suitable diols include, but are not limited to, polyether glycols, such as polytetramethylene ether glycols, commonly referred to as PTMEG. A suitable polytetramethylene ether glycol is available commercially from Invista® under the tradename Terathane®. A suitable isocyanate prepolymer is available commercially from Baxenden Chemicals Limited under the tradename Trixine SC 7931; this is a prepolymer formed from a polytetramethylene ether glycol and hexanediisocyanate (HDI).

The first species may be of the formula I

O═C═N—R¹—R²—R³—N═C═O formula I,

wherein R¹ and R³ each comprise an optionally substituted alkylene, preferably an optionally substituted alkylene directed bonded to the O═C═N— or —N═C═O group, respectively, and
R² is absent or an organic linker group.

The organic linker group is not particular restricted and it is considered by the present inventor that any group that links the isocyanate groups would suffice. Different organic linker groups may be selected depending on the desired properties of the final polymer. Preferably, such an organic linker group does not have any substituents that may react with the isocyanate groups, such as hydroxy, halo, amino, alkyl- or dialkylamino or thio-containing groups.

R² may be an organic linker group comprising a moiety selected from an aliphatic moiety, an aromatic moiety, a polymeric moiety formed from the polymerisation of one or more monomers, and combinations thereof; such polymeric moieties may be selected from, for example, polyalkylene, such as polyethylene or polypropylene, polyurethane, polyester, polyurea, polyether and polycarbonate.

Optionally, in the formula I above, —R¹— is —Y¹—NH—C(═O)—,

—R²— is an organic linker group, optionally selected from those mentioned above, for example —O—[(CH₂)ₙ—O—]ₘ— and
—R³— is —C(═O)—NH—Y²—, wherein
Y¹ and Y² are each independently selected from an aliphatic or an aromatic group, preferably an alkylene group,
n is from 1 to 8, preferably 2 to 6, most preferably 4, and
m is from 1 to 50, preferably from 5 to 35, most preferably from 10 to 30.

The first species may be of the formula II

O═C═N—R⁴—N═C═O formula II,

wherein R⁴ is an optionally substituted alkylene.

The first species may comprise three alkylene isocyanate groups on each molecule. The first species may comprise an isocyanurate of one or more isocyanates, for example those mentioned above, optionally those of formula I or formula II. Preferred isocyanurates are those formed from isocyanates of formula II, most preferably when R⁴ is a straight chain alkylene containing from 4 to 8 carbons, optionally 6 carbons. The isocyanate may be of formula V

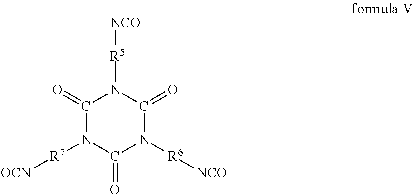

wherein R⁵, R⁶ and R⁷ are each independently an optionally substituted alkylene. R⁵, R⁶ and R⁷ may each be a straight chain alkylene containing from 4 to 8 carbons, optionally 6 carbons.

Suitable isocyanurates are available commercially, for example from Perstorp under the tradename Tolonate® HDT, which is of formula V above in which R⁵, R⁶ and R⁷ are each —(CH₂)₆—.

Optionally, the first species may comprise at least one aromatic isocyanate group, although they have not generally been found to be as effective in the present invention as aliphatic isocyanates. An aromatic isocyanate is a species that comprises an aromatic group within its structure and at least one isocyanate group; preferably the aromatic group is directly attached to one or more isocyanate groups. Such aromatic isocyanates include, but are not limited to, the 4,4′-, 2,4′ and 2,2′-isomers of diphenylmethane diisocyante (MDI), blends thereof and polymeric and monomeric MDI blends, toluene-2,4- and 2,6-diisocyanates (TDI), m- and p-phenylenediisocyanate, chlorophenylene-2,4-diisocyanate, diphenylene-4,4′-diisocyanate, 4,4′-diisocyanate-3,3′- dimethyldiphenyl, 3-methyldiphenyl-methane-4,4′-diisocyanate, diphenylether-diisocyanate, 2,4,6-triisocyanatotoluene and 2,4,4′-triisocyanatodiphenylether, and mixtures thereof.

Aliphatic, when mentioned herein, includes, but it not limited to, linear, cyclic or branched optionally substituted alkyl, alkylene, alkene, alkenylene, alkyne and alkynylene groups, preferably alkyl or alkylene, optionally containing from 1 to 20 carbon atoms, optionally preferably from 2 to 10 carbon atoms, not including any substituents that may be present.

Alkylene, when mentioned herein, includes, but it not limited to, linear, cyclic or branched optionally substituted alkylene, optionally containing from 1 to 20 carbon atoms, optionally from 2 to 10 carbon atoms, not including any substituents that may be present. Alkylene includes, but is not limited to, a species of formula —(CH₂)ₙ—, where n is 1 to 20, preferably from 2 to 10, more preferably from 4 to 8, optionally 5, 6 or 7.

Aromatic, when mentioned herein, includes, but is not limited to, optionally substituted phenyl and naphthyl.

Optional substituents include, but are not limited to, —NO₂, optionally substituted phenyl, aryl, heteroaryl, arylalkyl, alkylaryl, heteroarylalkyl, alkylheteroaryl, alkoxy, aryloxy, arylalkoxy, acyl, aroyl, nitro, cyano, carboxy, alkoxycarbonyl, aryloxycarbonyl, arylalkoxycarbonyl, alkylsulfonyl, arylsulfonyl, heteroarylsulfonyl.

Alkyl, when mentioned herein, includes, but it not limited to, linear, cyclic or branched optionally substituted alkyl group, preferably containing from 1 to 20 carbon atoms, most preferably from 2 to 10 carbon atoms, not including any substituents that may be present on the alkyl group.

Aryl, where mentioned herein, includes an aromatic group, including, but not limited to, optionally substituted phenyl and naphthyl.

“Molecule”, when used herein, may refer to a neutral species or a charged species, for example an organic salt, depending on the nature of the first and/or second species.

### Second Species

The second species comprises an aziridine, which is a species comprising one or more aziridine groups on each molecule. The second species may be any suitable molecule that contains one or more aziridine groups.

If the second species comprises a single aziridine group on each molecule, it may further comprise one or more other groups on the molecule that can react and form a bond with either an isocyanate group or an aziridine group. The one or more other groups may, for example, be selected from hydroxy, amine and isocyanate groups. In an embodiment, the second species does not have any substituents that may react with the isocyanate groups, other than the aziridine group. The second species may lack a hydroxy group, for example, a primary and/or secondary hydroxy group. The second species may, for example, lack an amino group, for example, a primary and/or secondary amino group. The second species may, for example, lack a thio-containing group. Substituents that may react with the isocyanate groups, include, but are not limited to hydroxy, e.g. primary and/or secondary hydroxy, amino, alkyl- or dialkylamino or thio-containing groups.

The second species may comprise two or more aziridine groups on each molecule; such species are sometimes termed in the art as polyfunctional aziridines or polyaziridines. The second species may comprise three or more aziridine groups.

The aziridine may be of the formula III

R—[X—N(Y)]_{z} formula III

wherein R is an optionally substituted aliphatic moiety or hydrogen X is an organic linker group, which may comprise one or more of an alkylene, an ester, an ether and an amide linkage,
—N(Y) is an aziridine group, optionally selected from —N(CH₂)₂ or —N(CH₂—CHMe) and z, when R is an aliphatic moiety, is 2 or more, preferably 2 to 4.

Preferably, in formula III, X is of the formula IV

—(CH₂)ₙ—O—CO—(CH₂)ₗ formula IV

wherein n is from 1 to 3, I is from 1 to 3 and z is 3 and R— is a CH₃—CH₂—C — or HO—CH₂—C—, and more preferably n is 1, I is 2 and z is 3 and R— is a HO—CH₂—C—.

Example of polyfunctional aziridines include, but are not limited to, pentaerythritol-tri-(beta-(N-aziridi nyl)propionate) and trimethylol-propane-tri(beta-(N-aziridinyl)propionate), and mixtures thereof. Polyfunctional aziridines are available commercially, an example of which is the polyfunctional aziridine sold under the tradename XAMA ® 7, made by Bayer Material Science.

Another suitable aziridine is phenyl-1-azirdine-ethanol, which is also available commercially. Many other types of aziridines may be used.

### Carrying out the Reaction/Polymerisation

The molar ratio of the first species to the second species, if different, is not particularly restricted. The molar ratio of the first species to the second species, if different, is about n:1, where n is about 1 or more. If n is more than 1, this has been found to be advantageous if it is desired to slow the onset of the reaction, for example when the first and second species are brought into contact with water. Optionally, n is about 1 to about 1.5. In an embodiment, n may be about y/x or more, where where x is the number of isocyanate groups on each molecule of the first species and y is the number of aziridine groups on each molecule of the second species. In an embodiment, n may be about 3y/x or more.

The first species preferably comprises a polyisocyanate, e.g. a diisocyanate or triisocyanate, and the second species preferably comprises an aziridine species having two or more, preferably three or more, aziridine groups in each molecule. This has been found to produce a polymer which can coat a surface and provide a durable, strong coating. It is believed that the aziridine and the diisocyanate species react and form a crosslinked polymer. The first and/or second species may be a polymer, and in the method of the present invention, the polymer is further extended.

The isocyanate-containing species and the aziridine-containing species used to carry out the polymerisation may be referred to collectively as reactants. Reactants may, for example, be selected from (i) a species comprising an isocyanate group and an aziridine group and (ii) a first species comprising an isocyanate group and a second species comprising an aziridine group, as described herein.

The reactants, e.g. the first and second species, may be contacted (if different) and/or stored in anhydrous or substantially anhydrous conditions prior to formation of the polymer. This may be, for example, in a vacuum or in an environment where any gas in contact with the first and second species contains little or no moisture. Such a gas may include any gas that is relatively inert and will not react with either of the first or second species. Such a gas may be selected from, but is not limited to, dry air, dry nitrogen, helium, neon and argon. The gas in the anhydrous or substantially anhydrous conditions preferably has a low humidity ratio. Humidity ratio of a particular gas is a measurement known to the skilled person and is a ratio of the kilograms of water per kilogram of the dry gas, at a given temperature and pressure. The gas in the anhydrous or substantially anhydrous conditions preferably contains 0.1 g or less of water per 1 kg³ of the dry gas (a humidity ratio of 0.0001 or less or about 100 ppm or less by weight water), preferably 0.05 g or less of water (a humidity ratio of 0.00005 or less or about 50 ppm or less by weight water), more preferably 0.02 g or less of water per 1 kg³ of the dry gas (a humidity ratio of 0.00002 or less or about 20 ppm or less by weight water), when measured at 20° C. and a pressure of from 101.325 kPa. An example of a suitable gas is dry nitrogen, containing 8 ppm or less of water; such a gas is available commercially from BOC.

The reactants, e.g. the first and second species, may be contacted (if different) and/or stored together in anhydrous or substantially anhydrous conditions, optionally as described above, prior to formation of the polymer, then contacted with water and/or a water-containing gas to form the polymer. Alternatively, if the first and second species are different, they may be contacted in the presence of water and/or a water-containing gas to initiate the polymerisation. The water may be in liquid or gaseous form. The water-containing gas should contain sufficient water to initiate and/or promote the reaction between the reactants, e.g. the first and second species, for example sufficient water to allow at least some formation of carbamic acid species from the isocyanate groups in the first species. The present inventor has found that exposure of the reactants, e.g. the first and second species, to ambient air generally results in a very fast reaction to form the polymer of the present invention. Preferably, the water-containing gas contains more than 1 g of water per 1 kg³ of the dry water-containing gas (a humidity ratio of more than 0.001), more preferably 5 g or more of water per 1 kg³ of the dry water-containing gas (a humidity ratio of 0.005 or more), still more preferably 8 g or more of water per 1 kg of the dry water-containing gas (a humidity ratio of 0.008 or more), when measured at 20° C. and a pressure of from 101.325 kPa. The water-containing gas may have a relative humidity of 10% or more, preferably 20% or more, most preferably 40% or more under the conditions at which the polymerisation is carried out.

The method of the present invention may comprise storing the reactants, e.g. the contacted first and second species, under anhydrous or substantially anhydrous conditions, and then disposing the reactants, e.g. the contacted first and second species, onto a substrate and contacting the reactants, e.g. the first and second species, with water or a water-containing gas to form the polymer of the present invention, which may form a coating on the substrate. The reactants, e.g. the first and second species, may be contacted with the water or the water-containing gas after contacting the substrate. If the reactants, e.g. the first and second species, are contacted with the water or water-containing gas before contacting the substrate, preferably, the time between the contacting of the reactants with the water or the water-containing gas and the contacting of the reactants with the substrate is less than 30 seconds, more preferably less than 20 seconds, still more preferably less than 10 seconds.

The polymerisation may be carried out at any suitable temperature at which the reactants can polymerise. The reaction may be carried out at high temperatures, for example at a temperature above 100° C., optionally above 150° C. However, the present inventor has found that the reaction may proceed at an acceptable rate without much, if any, heating, for example at temperatures from 0 to 40° C.

The polymerisation may be carried out in the presence of air, which may be at any suitable air pressure. Such an air pressure may be from, for example, about 50 kPa to about 200 kPa, most preferably about 90 kPa to about 110 kPa.

The reactants, e.g. first and second species, may be contacted (if different) and/or stored in a carrier medium. The polymerisation may be carried out in a carrier medium, which may be the same as the carrier medium in which they are contacted and/or stored. Any suitable carrier medium may be used that allows the first and second species to react to form a polymer, but will not itself react with the first or second species. Such a carrier medium may comprise a solvent. The solvent may be a polar or a non-polar solvent, dependent on the nature of the first and second species. Non-polar, non-protic solvents are generally preferred. Preferably, the solvent is a urethane grade solvent; such solvents are known to the skilled person. A urethane grade solvent includes, but is not limited to, a solvent that is anhydrous or substantially anhydrous, for example a solvent containing less than 500 ppm by weight of water, preferably less than 300 ppm by weight of water. The solvent may be selected from xylene, methylene chloride, perchloroethylene, chloroform, carbon tetrachloride, chlorobenzene, acetone, 2-butanone, 2-pentanone, methyl acetate, ethyl acetate, propyl acetate, butyl acetate, methyl propionate, ethyl propionate, a dialkylether of ethylene glycol wherein the alkyl groups contain 1 to 4 carbon atoms, a dialkylether of propylene glycol wherein the alkyl groups contain 1 to 4 carbon atoms, parafinnic solvents such as naphtha, hexane, benzene, toluene, diethyl ether, chloroform, and mixtures thereof. The amount of solvent may be determined by the skilled person, depending on the nature of the first and second species. The weight ratio of solvent:reactants may be from about 20:1 to about 1:20, where “reactants” in this context is the total weight of the isocyanate-containing and aziridine containing species in the solvent. A lower amount of solvent will increase the likelihood that a foamed polymer will be formed. The amount of solvent may be selected such that, as polymerisation is carried out, any carbon dioxide or other gas formed or released during polymerisation is allowed to escape from the solvent, thus avoiding a foamed polymer.

If the polymerisation is carried out in a carrier medium, such as a solvent, the carrier medium may be removed following polymerisation. A carrier medium, such as a solvent, containing the polymer of the present invention may be contacted with a substrate, and the carrier medium removed to form a coating of the polymer on the substrate. The carrier medium may be brought into contact with the substrate on which the coating is to be formed before, during or after the formation of the polymer. If the carrier medium is a solvent, it may be selected such that the reactants and/or the polymer is soluble in the carrier medium.

Optionally, the first and second species are reacted in a reaction mixture, which at the beginning of the reaction consists essentially of or consists of the first and second species, and, optionally, a carrier medium and/or water. Optionally, the first and second species are reacted in a reaction mixture, which at the beginning of the reaction consists essentially of the first and second species, water and, optionally, a carrier medium. In this context, “consists essentially of” includes, but is not limited to, a reaction mixture, which, at the beginning of the reaction, contains less than 5% by weight of components other than the first and second species and, if present, the carrier medium and/or water, optionally less than 2% by weight of components other than the first and second species and, if present, the carrier medium and/or water, optionally less than 1% by weight of components other than the first and second species and, if present, the carrier medium and/or water, optionally less than 0.5% by weight of species other than the first and second species and, if present, the carrier medium and/or water, optionally less than 0.1% by weight of species other than the first and second species and, if present, the carrier medium and/or water. The reaction mixture, when the reaction is carried out, may comprise or be a liquid.

Optionally, the reaction mixture, at the beginning of the reaction and/or during the reaction, is substantially free of components, other than the first and second species and, if present, water, having groups that can react with an isocyanate group and/or an aziridine group. In this context, “substantially free” includes, but is not limited to, a reaction mixture containing less than 5% by weight of components, other than the first and second species and, if present, water, having groups that can react with an isocyanate group and/or an aziridine group, optionally less than 2% by weight of components , other than the first and second species and, if present, water, having groups that can react with an isocyanate group and/or an aziridine group, optionally less than 1% by weight of components, other than the first and second species and, if present, water, having groups that can react with an isocyanate group and/or an aziridine group, optionally less than 0.5% by weight of components, other than the first and second species and, if present, water, having groups that can react with an isocyanate group and/or an aziridine group, optionally less than 0.1% by weight of components, other than the first and second species and, if present, water, having groups that can react with an isocyanate group and/or an aziridine group. Groups that can react with an isocyanate group and/or an the isocyanate group include, for example, nucleophilic groups, including, but not limited to, a hydroxy group, e.g. a primary and/or secondary hydroxy group, an amino group, for example, a primary and/or secondary amino group, a thio-containing group, a carboxy-group, and negatively charged anions.

Optionally, the polymer comprises a polyamine polymer. Preferably, the polymer formed contains at least one —NH—CH₂—CH₂—NH— linkage. Without being bound by theory, it is believed that, when water is present, and particularly when the first species comprises an aliphatic isocyanate, a carbamic acid moiety is formed from the combination of the isocyanate with the water, which then combines with the aziridine group. The resultant species is then believed to rearrange to form a species having a —NH—CH₂—CH₂—NH— linkage. The —NH—CH₂—CH₂—NH— linkage may further react with the isocyanates to form a cross-linked polymer.

In a C13 NMR spectrum, the polymer may have a peak within the range of from 157 to 161 ppm, optionally at about 159 ppm. In a 15N NMR spectrum, the polymer may have a peak within the range of from 81 to 85 ppm, optionally at about 83 ppm.

The polymer may be formed or deposited on a substrate to form a coating on the substrate. Many types of substrate may be used. The substrate may be a solid substrate. The substrate may be porous or non-porous. The substrate may comprise a material selected from a metal, metal compound, an organic compound or a semi-metal or semi-metal compound. The substrate may include, but is not limited to, materials comprising or consisting of metals or alloys, including but not limited to iron, steel, copper, brass and aluminium; polymeric materials, such as plastics or rubbers; ceramic materials, such as glass, oxides of various metals, oxides of aluminium and zirconium, such as alumina and zirconia, carbides, borides, nitrides and silicides; materials suitable for use as or on road or pavement surfaces, such as concrete, asphalt concrete and stone; fabrics, such as cotton or polyester.

The substrate may be a road or pavement (sidewalk) surface.

A pigment may be present in the formed polymer. The present invention further provides a paint composition comprising the first and second species and/or the polymer of the present invention.

The polymer may be transparent or translucent.

The polymer may be formed in a mould and then removed from the mould. A suitable material for use on the surface of the mould includes, for example, silicone.

The polymer may be in the form of a sheet, depending on the desired application.

The present invention provides an article comprising a first substrate and a second substrate, wherein first and second substrate are adhered together by the polymer of the present invention. The first and/or second substrate may each independently be a substrate as described above.

The present invention will now be described with reference to the following non-limiting Examples and the accompanying Figures.

### BRIEF DESCRIPTION OF THE FIGURES

All of FIGS. 1 to 7 show IR and NMR spectra of the reactants and/or products as used or produced in Example 1 below.

FIG. 1 shows an IR spectra of the reaction mixture of Example 1 below at various points over time, from before the reaction has started (denoted “without air” in the Figure) through to 21 minutes after contact with ambient air.

FIG. 2 shows a C13 NMR spectrum for the reactant HDT alone in solution.

FIG. 3 shows an N15 NMR spectrum for the reactant HDT alone in solution.

FIG. 4 shows a C13 NMR spectrum for the reaction product produced in Example 1.

FIG. 5 shows an N15 NMR spectrum for the reaction product produced in Example 1.

FIG. 6 shows an N15 NMR spectrum for the reaction product produced in Example 1, with suppression of protonated nitrogens.

FIG. 7 shows an N15 NMR spectrum for Xama-7 alone in solution.

### EXAMPLES

The following reactions were all carried out at room temperature and pressure (20° C. and 101.325 kPa).

### Example 1

25.2 g Tolonate® HDT (0.05 moles), an isocyanurate of hexane diisocyanate (commercially available from Perstorp) and 16.01 g (0.04 moles) Xama® 7 poly aziridine (commercially available from), which were both liquids, were mixed together and stored under dry nitrogen (commercially available from BOC and containing 8 ppm by weight water or less), then poured on a substrate and exposed to atmospheric moisture, i.e. air having a relative humidity of from 20 to 80%. The experiment was carried out on glass and steel substrates. The resultant material is a rapidly hardening polymer which blows due to the elimination of carbon dioxide in the formation of the polymer. The process of this example formed a foamed polymer layer on the substrate. This was carried out on substrates of glass and steel.

### Example 2

184.9 g (0.05 moles) of diisocyanate prepolymer (Baxenden's Trixine SC 7931), based on PTMEG and HDI (hexane diisocyanate), and the naphtha solvent in which it was supplied (about 46 g), and 10.68 g (0.03 moles) Xama® 7 poly aziridine (commercially available from BASF) were mixed together and stored under dry nitrogen (commercially available from BOC and containing 8 ppm by weight water or less), then poured on a substrate and exposed to atmospheric moisture, i.e. air having a relative humidity of from 20 to 80%. The resultant product is soluble within the solvent naphtha prior to the rearrangement, allowing the carbon dioxide to escape. A number of substrates were coated, including polyethylene, glass and steel. On drying, a tough polyamine linked PTMEG-based coating is formed on each substrate with high physical and chemical resistance performance.

### IR and NMR Studies

IR and NMR studies were carried out on the reaction product formed in Example 1 above and the results are given in the Figures and below.

### Experimental

The reactions were followed using Nicolet Avatar 360 FTIR with Ge single bounce ATR and KBr disk transmission Probes.

Structural changes were recorded on a Bruker Avance 3 spectrometer, operating at a resonance frequency of 500.13 MHz for protons.

Spectra of solutions were recorded in a 5 mm triple resonance inverse probe, at room temperature. Chemical shifts are referenced to the deuterium lock - no additional shift reference was used.

Spectra of solids were acquired under magic-angle spinning, at a rotation frequency of 8 kHz, in 4 mm rotors. Sample volumes are approximately 50 μL. Spectra were acquired using cross-polarisation, with a contact time of 2 msec for the carbon spectra, and 5 msec for the nitrogen spectra. All spectra were acquired with proton decoupling using the SPINAL-64 sequence at an RF field strength of 70 kHz. The edited nitrogen spectrum was recorded using the non-quaternary suppression sequence, with a dephasing delay of 100 μ-sec.

Chemical shifts in the solid-state spectra are referenced to an external standard, solid adamantane. The high-shift peak of adamantane is set to 37.77 ppm as per IUPAC recommendations.

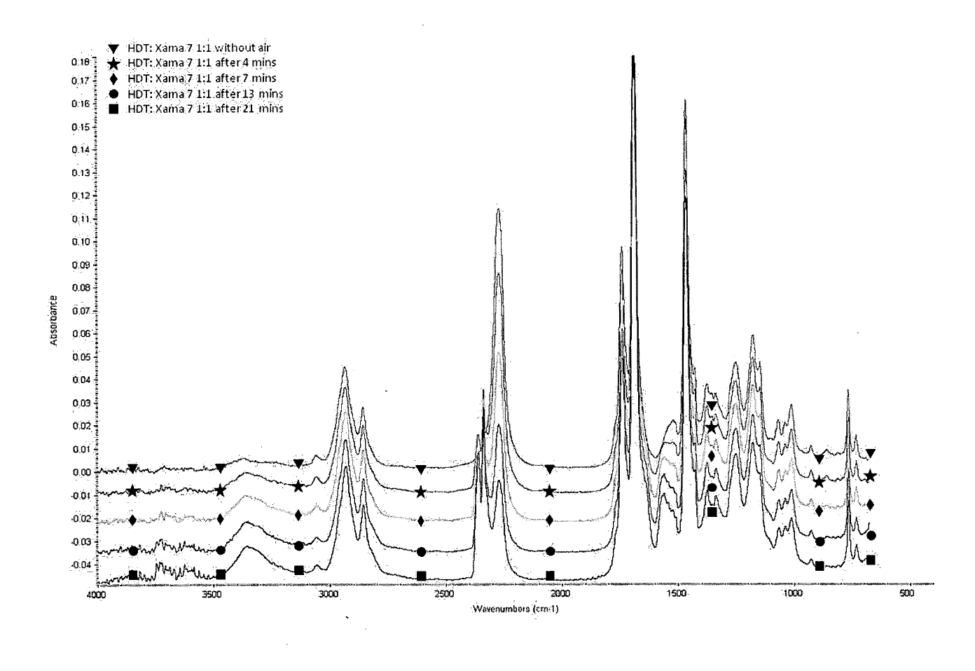

FIG. 1 shows an IR spectra of the reaction mixture in Example 1 at various points over time, from before the reaction has started (denoted “without air” in the Figure) through to 21 minutes after contact with ambient air.

Table I below shows the 13C and 15N peaks in HDT, Xama-7 and reaction product formed in Example 1.

TABLE I

| | | | | |
|---|---|---|---|---|
| HDT: | | | 13C | 15N |
| | A | NCO | 122 ppm | 30 ppm |
| | B | amide ring | 149 ppm | 140 ppm |
| Xama-7: | | | | |
| | C | C═O | 171 ppm | |
| | D | Aziridine | | 112 ppm |
| Polymer: | | | | |
| | E | from HDT group | 149 ppm | 140 ppm |
| | F | from XAMA C═O | 171 ppm | |
| | G | newly formed C═O | 159 ppm | |
| | H | Newly formed N—H | | 83 ppm |

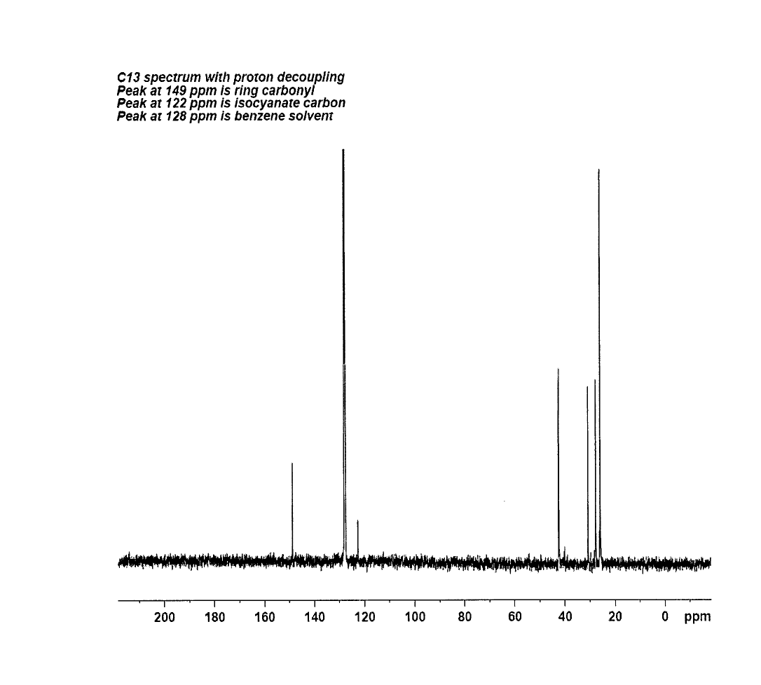

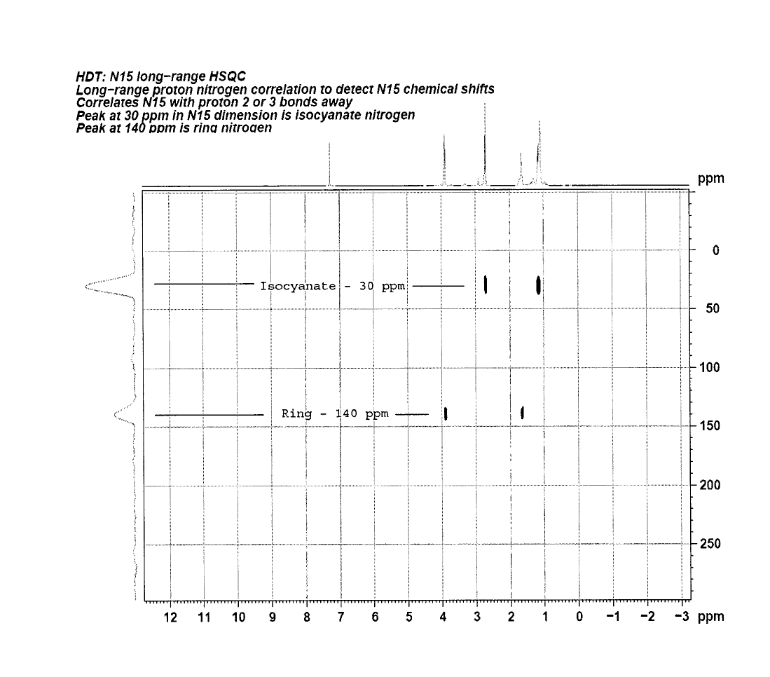

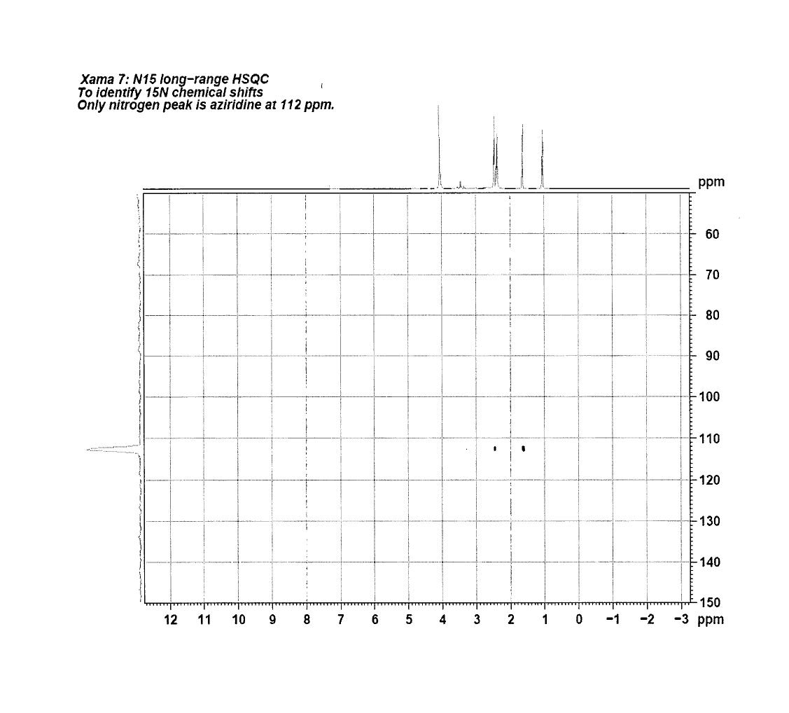

The results from Table I were drawn from FIGS. 2 to 7 (also denoted Spectrum I to VI, respectively). FIGS. 2 and 3 show NMR spectra for HDT alone in solution and FIG. 7 shows NMR spectra for Xama-7 alone in solution; these spectra were used to identify the starting groups and chemical shifts. FIGS. 3 to 6 show NMR spectra for the reaction product formed in Example 1.

The tables that appeared on the original print-outs of the NMR spectra shown FIGS. 2 to 7 are reproduced at the end of the description.

### INDUSTRIAL APPLICABILITY

The process of the present invention provides a synthetic route to novel polymers that are useful in many applications. The process can proceed very rapidly, typically in the absence of catalysts. The applications for which the polymers may be used include, but are not limited to, coating of road and pavement surfaces, use in high-durability paints, coatings for lenses to improve their anti-scratch properties, inclusion in glues for surgery and first aid, low permeability waterproof membranes, U.V. blockers for hair dyes, hair gels, lipstick and lip gloss, use as or in aquatic life saving equipment, such as buoyancy aids.

The tables that appeared on the original print-outs of the NMR spectra from FIGS. 2 to 7 are reproduced below.

| FIG. 2 (Spectrum I) | | |
|---|---|---|
| NAME | hdt | |
| EXPNO | 34 | |
| PROCNO | 1 | |
| Date_ | 20081121 | |
| Time | 16.37 | |
| INSTRUM | spect | |
| PROBHD | 5 | mm TXI 1H/D- |
| PULPROG | zgpg30 | |
| TD | 65536 | |
| SOLVENT | C6D6 | |
| NS | 32 | |
| DS | 4 | |
| SWH | 29761.904 | Hz |
| FIDRES | 0.454131 | Hz |
| AQ | 1.1010549 | sec |
| RG | 203 | |
| DW | 16.800 | usec |
| DE | 9.47 | usec |
| TE | 299.1 K | |
| D1 | 2.00000000 | sec |
| D11 | 0.3000000 | sec |

| | |
|---|---|
| TD0 | 1 |

CHANNEL f1

| NUC1 | 13C | |
|---|---|---|
| P1 | 11.19 | usec |
| PL1 | −4.00 | dB |
| PL1W | 206.95401001 | W |
| SFO1 | 125.7703643 | MHz |

CHANNEL f2

| CPDPRG2 | waltz16 | |
|---|---|---|
| NUC2 | 1H | |
| PCPD2 | 80.00 | usec |
| PL2 | 1.10 | dB |
| PL12 | 25.02 | dB |
| PL13 | 25.00 | dB |
| PL2W | 14.23386574 | W |
| PL12W | 0.11516561 | W |
| PL13W | 0.05798596 | W |
| SFO2 | 500.1320005 | MHz |
| SI | 65536 | |
| SF | 125.7577890 | MHz |
| WDW | EM | |
| SSB | 0 | |
| LB | 4.00 | Hz |
| GB | 0 | |
| PC | 4.00 | |
| FIG. 3 (Spectrum II) | | |
| NAME | hdt | |
| EXPNO | 37 | |
| PROCND | 1 | |
| Date_ | 20081121 | |
| Time | 16.56 | |
| INSTRUM | spect | |
| PROBHD | 5 | mm TXI 1H/D- |
| PULPROG | hmbof3.ptg | |
| TD | 2049 | |
| SOLVENT | C6D6 | |
| NS | 9 | |
| DS | 9 | |
| SWH | 9012.820 | Hz |
| FIDRES | 3.912510 | Hz |
| AQ | 0.1278452 | sec |
| RG | 64 | |
| DW | 62.400 | usec |
| DE | 6.50 | usec |
| TE | 299.1K | |
| CNST13 | 6.0000000 | |
| D0 | 0.00000300 | sec |
| D1 | 1.00000000 | sec |
| D6 | 0.08333334 | sec |
| D16 | 0.00010000 | sec |
| INO | 0.00002820 | sec |

CHANNEL f1

| NUC1 | 1H | |
|---|---|---|
| P1 | 6.29 | usec |
| P2 | 12.56 | usec |
| PL1 | 1.10 | dB |
| PL1W | 14.23386574 | W |
| SP01 | 500.1323755 | MHz |

CHANNEL f3

| NUC3 | 15N | |
|---|---|---|
| P21 | 35.00 | usec |
| PL3 | −1.80 | dB |
| RL3W | 194.65696716 | W |
| SPO3 | 50.6839575 | MHz |

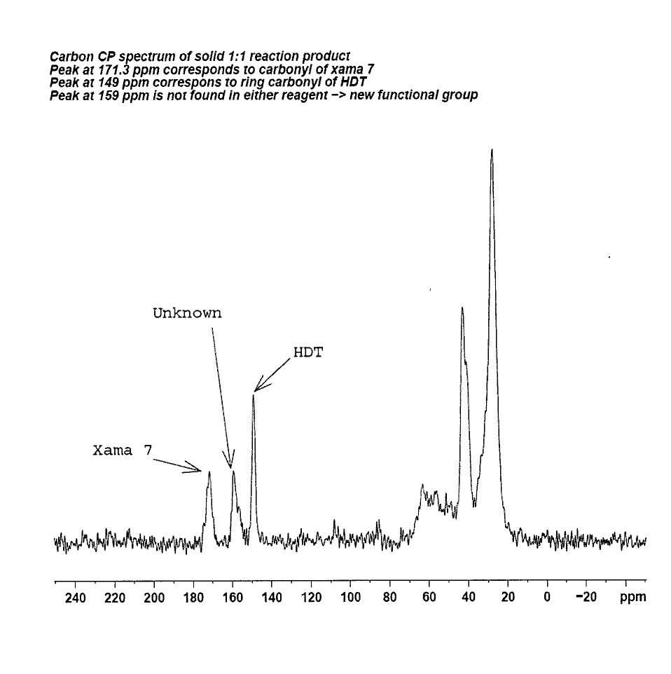

GRADIENT CHANNEL

| GPNAM1 | SINE.100 | |
|---|---|---|
| GPNAM2 | SINE.100 | |
| GPNAM3 | SINE.100 | |
| GPZ1 | 70.00% | |
| GPZ2 | 30.00% | |
| GPZ3 | 50.10% | |
| P16 | 1000.00 | usec |
| NDO | 2 | |
| TD | 47 | |
| SPO1 | 50.68396 | MHz |
| FIDRES | 377.433716 | Hz |
| SW | 350.000 | ppm |
| FnMODE | QF | |
| SI | 2049 | |
| SF | 500.1300000 | MHz |
| WDW | QSINE | |
| SSB | 0 | |
| LB | 0.00 | Hz |
| GB | 0 | |
| PC | 4.00 | |
| SI | 256 | |
| MC2 | QF | |
| SF | 50.6777330 | MHz |
| WDW | QSINE | |
| SSB | 0 | |
| LB | 0.00 | Hz |
| GB | 0 | |
| FIG. 4 (Spectrum III) | | |
| NAME | topaz | |
| EXPNO | 1 | |
| PROCNO | 1 | |
| Date_ | 20081126 | |
| Time | 15.53 | |
| INSTRUM | spect | |
| PROBHD | 4 | mm MAS BB/1H |
| PULPROG | cp | |
| TD | 1132 | |
| SOLVENT | C6D6 | |
| NS | 128 | |
| DS | 0 | |
| SWH | 37878.789 | Hz |
| FIDRES | 33.461826 | Hz |
| AQ | 0.0149924 | sec |
| RG | 128 | |
| DW | 13.200 | usec |
| DE | 7.70 | usec |
| TE | 690.2K | |
| CNST11 | 0.0000000 | |
| D1 | 5.00000000 | sec |

ZGOPTNS

CHANNEL f1

| NUC1 | 13C | |
|---|---|---|
| P15 | 2000.00 | usec |
| PL1 | 0.20 | dB |
| PL1W | 100.99086761 | W |
| SFO1 | 125.7703648 | MHz |

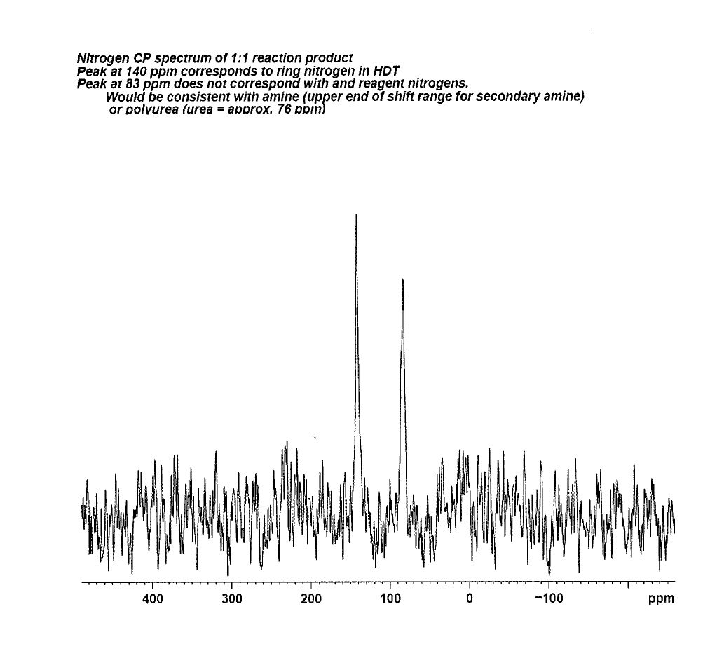

CHANNEL, f2

| CNST21 | 1.0000000 | |
|---|---|---|
| CPDPRG2 | spinal64.13 | |
| NUC2 | 1H | |
| P3 | 2.60 | usec |
| PCPD2 | 6.60 | usec |
| PL2 | 120.00 | dB |
| PL12 | −1.70 | dB |
| PL13 | 1.30 | dB |
| SFO2 | 500.1315004 | MHz |
| SPO | −0.30 | dB |
| SPNAM0 | ramp.100 | |
| SPOAL0 | 0.500 | |
| SPOFFS0 | 0.00 | Hz |
| SI | 16384 | |
| SF | 125.7577890 | MHz |
| WDW | no | |
| SSB | 0 | |
| LB | 0.00 | Hz |
| GB | 0 | |
| PC | 0.20 | |
| FIG. 5 (Spectrum IV) | | |
| NAME | topaz | |
| EXPNO | 10 | |
| PROCNO | 1 | |
| Date_ | 20081126 | |
| Time | 16.49 | |
| INSTRUM | spect | |
| PROBHD | 4 | mm MAS BB/1H |
| PULPROG | cp | |
| TD | 1132 | |
| SOLVENT | C6D6 | |
| NS | 10240 | |
| DS | 0 | |
| SWH | 37878.789 | Hz |
| FIDRES | 33.461826 | Hz |
| AQ | 0.0149924 | sec |
| RG | 128 | |
| DW | 13.200 | usec |
| DE | 11.00 | usec |
| TE | 690.2K | |
| CNST11 | 0.0000000 | |
| D1 | 5.00000000 | sec |

ZGOPTNS

CHANNEL f1

| NUC1 | 15N | |
|---|---|---|
| P15 | 5000.00 | usec |
| PL1 | 0.00 | dB |
| PL1W | 128.60858154 | W |
| SFO1 | 50.6835609 | MHz |

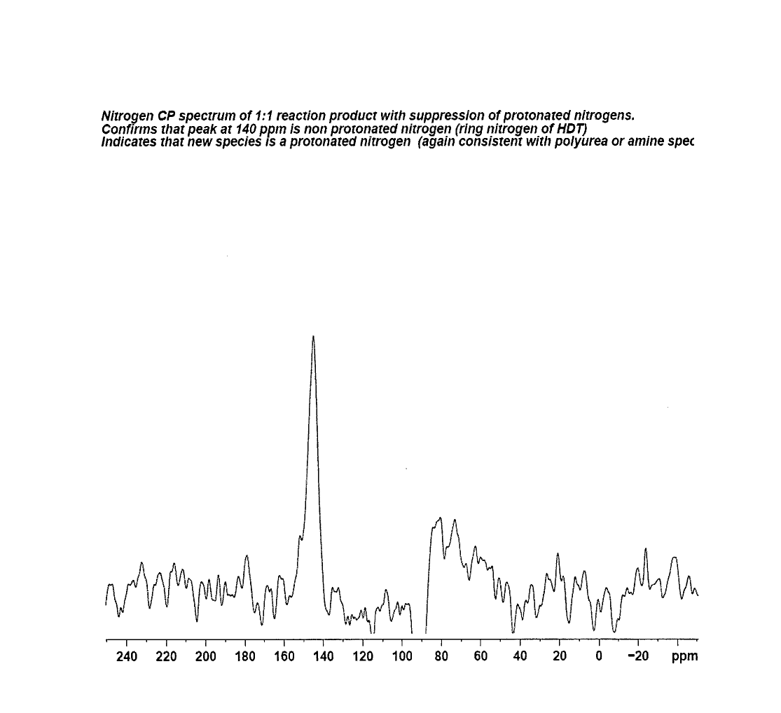

CHANNEL f2

| CNST21 | 1.0000000 | |
|---|---|---|
| CPDPRG2 | spinal64.13 | |
| NUC2 | 1H | |
| P2 | 2.60 | usec |
| PCPD2 | 6.60 | usec |
| PL2 | 120.00 | dB |
| PL12 | −1.70 | dB |
| PL13 | 1.30 | dB |
| SFO2 | 500.1315004 | MHz |
| SPO | 3.10 | dB |
| SPNAM0 | ramp.100 | |
| SPOAL0 | 0.500 | |
| SPOFFS0 | 0.00 | Hz |
| SI | 16384 | |
| SF | 50.6777330 | MHz |
| WDW | EM | |
| SSB | 0 | |
| LB | 50.00 | Hz |
| GB | 0 | |
| PC | 0.20 | |
| FIG. 6 (Spectrum V) | | |
| NAME | topaz | |
| EXPNO | 12 | |
| PROCNO | 1 | |
| Date_ | 20081201 | |
| Time | 16.34 | |
| INSTRUM | spect | |
| PROBHD | 4 | mm MAS BB/1H |
| PULPROG | cpnqs.ptg | |
| TD | 1132 | |
| SOLVENT | C6D6 | |
| NS | 10240 | |
| DS | 0 | |
| SWH | 37878.789 | Hz |
| FIDRES | 33.461826 | Hz |
| AQ | 0.0149924 | sec |
| RG | 128 | |
| DW | 13.200 | usec |
| DE | 11.00 | usec |
| TE | 303.0K | |
| CNST11 | 0.0000000 | |
| D1 | 5.00000000 | sec |
| D20 | 0.00010000 | sec |

ZGOPTNS

CHANNEL f1

| NUC1 | 15N | |
|---|---|---|
| P15 | 5000.00 | usec |
| PL1 | 0.00 | dB |
| PL1W | 128.60815154 | W |
| SFO1 | 50.6835609 | MHz |

CHANNEL f2

| CNST21 | 1.0000000 | |
|---|---|---|
| CPDPRG2 | spina164.13 | |
| NUC2 | 1H | |
| P3 | 2.60 | usec |
| PCPD2 | 6.60 | usec |
| PL2 | 120.00 | dB |
| PL12 | −1.70 | dB |
| PL13 | 1.30 | dB |
| SFO2 | 500.1315004 | MHz |
| SPO | 3.10 | dB |
| SPNAM0 | ramp.100 | |
| SPOAL0 | 0.500 | |
| SPOFFS0 | 0.00 | Hz |
| SI | 16384 | |
| SF | 50.6777330 | MHz |
| WDW | EM | |
| SSB | 0 | |
| LB | 100.00 | Hz |
| GB | 0 | |
| PC | 0.20 | |
| FIG. 7 (Spectrum VI) | | |
| NAME | xama7 | |
| EXPNO | 9 | |
| PROCNO | 1 | |
| Date_ | 20081121 | |
| Time | 10.52 | |
| INSTRUM | spect | |
| PROBHD | 5 | mm TXI 1H/D- |
| PULPROG | hogcetf3gp | |
| TD | 2049 | |
| SOLVENT | CDCI3 | |
| NS | 2 | |
| DS | 9 | |
| SWH | 9012.820 | Hz |
| FIDRES | 3.912510 | Hz |
| AQ | 0.1279452 | sec |
| RG | 64 | |
| DW | 62.400 | usec |
| DE | 6.50 | usec |
| TE | 299.1K | |
| CNST4 | 10.0000000 | |
| D0 | 0.00000300 | sec |
| D1 | 1.00000000 | sec |
| D11 | 0.30000000 | sec |
| D13 | 0.00000400 | sec |
| D16 | 0.00010000 | sec |
| D26 | 0.02500000 | sec |
| INO | 0.00009865 | sec |

ZGOPTNE

CHANNEL f1

| NUC1 | 1H | |
|---|---|---|
| P1 | 7.19 | usec |
| P2 | 14.39 | usec |
| P28 | 0.00 | usec |
| PL1 | 1.10 | dE |
| PL1W | 14.23386574 | W |
| SF01 | 500.1323755 | MHz |

CHANNEL f3

| CPDPRG3 | garp | |
|---|---|---|
| NUC3 | 15N | |
| P21 | 35.00 | usec |
| P22 | 70.00 | usec |
| PCPD3 | 200.00 | usec |
| PL3 | −1.80 | dB |
| PL16 | 13.14 | dB |
| PL3W | 194.65686716 | W |
| PL16W | 5.96032524 | W |
| EPO3 | 50.6928009 | MHz |

GRADIENT CHANNEL

| GPNAM1 | SINE.100 | |
|---|---|---|
| GPNAM2 | SINE.100 | |
| GPNAM3 | SINE.100 | |
| GPZ1 | 50.00% | |
| GPZ2 | 80.00% | |
| GPZ3 | 8.10% | |
| P16 | 1000.00 | usec |
| NDO | 2 | |
| TD | 256 | |
| SF01 | 50.6829 | MHz |
| FIDRES | 19.797970 | Hz |
| SW | 100.00 | ppm |
| FnMODE | Echo-Antiecho | |
| SI | 2049 | |
| SF | 500.1300000 | MHz |
| WDW | QSINE | |
| SSB | 2 | |
| LB | 0.00 | Hz |
| GB | 0 | |
| PC | 4.00 | |
| SI | 256 | |
| MC2 | echo-Antiecho | |
| SF | 50.6777330 | MHz |
| WDN | QSINE | |
| SSB | 2 | |
| LB | 0.00 | Hr |

| | |
|---|---|
| GB | 0 |

1. A method of forming a polymer, the method comprising reacting a first species comprising at least one isocyanate group with a second species comprising at least one aziridine group to form the polymer.

2. A method according to claim 1, wherein the first and second species are polymerised in the presence of water.

3. A method according to claim 1 or claim 2, wherein the first and second species are polymerised in the presence of a water-containing gas.

4. A method according to any one of the preceding claims, wherein the first species comprises at least one alkyleneisocyanate group.

5. A method according to any one of the preceding claims, wherein the first species comprises at least two alkyleneisocyanate groups.

6. A method according to any one of the preceding claims, wherein the first species is of the formula I
O═C═N—R¹—R²—R³—N═C═O formula I,
wherein R¹ and R³ each comprise an optionally substituted alkylene and R² is absent or an organic linker group.

7. A method according to any one of the preceding claims, wherein R² is an organic linker group comprising a moiety selected from an aliphatic moiety, an aromatic moiety, a polymeric moiety formed from the polymerisation of one or more monomers, and combinations thereof.

8. A method according to any one of the preceding claims, wherein the first species is of the formula II
O═C═N—R⁴—N═C═O formula II,
wherein R⁴ is an optionally substituted alkylene.

9. A method according to any one of claims 1 to 5, wherein the first species comprises at least three alkyleneisocyanate groups.

10. A method according to claim 9, wherein the first species is an isocyanurate of the formula V 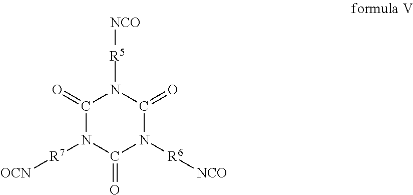
wherein R⁵, R⁶ and R⁷ are each independently optionally substituted alkylene.

11. A method according to any one of the preceding claims, wherein the second species comprises two or more aziridine groups.

12. A method according to any one of the preceding claims, wherein the second species comprises three or more aziridine groups.

13. A method according to any one of the preceding claims, wherein the molar ratio of the first species to the second species is about 1:1.

14. A method according to any one of the preceding claims, wherein the first and second species are reacted at a temperature of from 0 to 40° C.

15. A method according to any one of the preceding claims, wherein the first and second species are reacted in the presence of water, the first species comprises two or more isocyanate groups and the second species comprises comprises two or more aziridine groups.

16. A method according to any one of the preceding claims, wherein the first and second species are reacted in a reaction mixture, which at the beginning of the reaction consists essentially of the first and second species, water and, optionally, a carrier medium.

17. A method according to claim 1, wherein each of first and second species includes at least one isocyanate group and at least one aziridine group, and the first and second species are the same.

18. A method according to any one of the preceding claims, wherein, prior to formation of the polymer, first and second species are stored in anhydrous or substantially anhydrous conditions.

19. A method according to any one of the preceding claims, wherein, prior to formation of the polymer, first and second species are stored in anhydrous or substantially anhydrous conditions, and then water or a water-containing gas is contacted with the first and second species to form the polymer.

20. A method according to any one of the preceding claims, wherein the polymer is formed on a substrate to form a coating on the substrate.

21. A method according to any one of the preceding claims, wherein the polymer is formed in a mould and then removed from the mould.

22. A method according to any one of the preceding claims, wherein the first and second species are in contact with a first substrate and a second substrate, and the polymer formed, adhering the first substrate to the second substrate.

23. A method according to any one of the preceding claims, wherein a foamed polymer is formed.

24. A polymer formable by the method of as defined in any one of claims 1 to 23.

25. A substrate having a coating thereon, wherein the coating comprises a polymer as defined in claim 24.

26. A moulded article comprising a polymer as defined in claim 24.

27. An article comprising a first substrate and a second substrate, wherein first and second substrate are adhered together by a polymer as defined in claim 24.

28. A method of combining a first species with a second species in the presence of water to form a third species, the first species comprising at least one isocyanate group and the second species comprising at least one aziridine group.
